(19) United States
(12) Patent Application Publication
(10) Pub. No.: US 2004/0133295 A1
(43) Pub. Date: Jul. 8, 2004

(54) Controller and method for a fabric grooming device

(75) Inventors: Martin A. Cohen, Ridgefield, CT (US); Vito James Carlucci, Stratford, CT (US); Paul Joseph Denhup, Stratford, CT (US)

Correspondence Address: Charles N.J. Ruggiero, Esq., Ohlandt, Greeley, Ruggiero & Perle, L.L.P., One Landmark Square, 10th Floor, Stamford, CT, 06901-2682, US

(73) Assignee: Conair Corporation

(21) Appl. No.: 10/669,155

(22) Filed: Sep. 23, 2003

Related U.S. Application Data
(60) Provisional application No. 60/414,563, filed on Sep. 30, 2002.

(51) Int. Cl. G06F 19/00

(52) U.S. Cl. 700/130

(57) ABSTRACT

There is provided a controller for a fabric grooming device to provide optimal user convenience, operational ease, and efficiency in use. The controller has at least an interface, a microprocessor, a sound generator, one or more sensors, a heater, and a timer. The controller may also have any of a variety of other features, such as, for example, a vibrator. The controller can cooperate with any of a variety of grooming devices in a space-efficient manner, and offers the user a safe, effective and efficient way for interactive operative control of such devices.

### BACKGROUND OF THE INVENTION

1. Field of the Invention

The present invention relates to fabric grooming devices. More particularly, the present invention relates to a controller for a fabric grooming device.

2. Description of the Prior Art

It is known in the art for fabric grooming devices, such as for example a steamer or an iron, to have controls for controlling and/or manipulating the various components and/or features associated with such a device. With respect to available controls for such grooming devices, optimal user convenience, operational ease, efficiency in use of surface and display space, and safety are among various characteristics that are of high importance. Known grooming devices typically have fabric and/or temperature controls in the form of dedicated buttons or manual rotational dials. These conventional controls generally have only a limited number of selection options primarily due to limited space availability on the housing of the grooming device. Additional features such as head lights, steamers or sprayers, manual power buttons, and other like features also place constraints on the space availability associated with the housing of the grooming device.

Therefore, with limited space availability and the desirability of providing optimal user convenience, operational ease, and efficiency in use, there exists a need to provide a controller that can cooperate with any of a variety of devices in a space-efficient manner, and that offers the user a safe, effective and efficient way for interactive operative control of such devices.

### SUMMARY OF THE INVENTION

It is an object of the present invention to provide a controller for cooperating with a fabric grooming device, which controller has any of a variety of operational features.

It is another object of the present invention to provide such a controller with an input/output interface.

It is still another object of the present invention to provide a controller that allows for a variety of different methods of operation.

These and other objects and advantages of the present invention are achieved by a controller operatively connected to a fabric grooming device. The controller has at least an interface, a microprocessor, a sound generator, one or more sensors, a heater, and a timer. The controller may also have, or be operatively associated with, any of a variety of other features and/or components. The interface has both input and output elements that cooperate with the various features/components of the grooming device to provide interactive operational control thereof.

### BRIEF DESCRIPTION OF THE DRAWINGS

The present invention is more fully understood by reference to the following detailed description of an illustrative embodiment in combination with the drawings identified below.

FIG. 1 is a plan view of a controller and components in accordance with an illustrative embodiment of the present invention;

FIG. 2 is a plan view of a fabric grooming device in accordance with an illustrative embodiment of the present invention, showing the controller of FIG. 1 associated therewith;

FIG. 3 is a side-section view of the fabric grooming device of FIG. 2;

FIG. 4 is a schematic diagram of a control circuit in accordance with an illustrative embodiment of the present invention;

FIG. 5 is a schematic diagram of the control circuit of FIG. 4 in accordance with another aspect of the present invention;

FIG. 6 is a logic diagram of operational steps in accordance with an illustrative embodiment of the present invention;

FIG. 7 is a plan view of a schematic of the controller and components in accordance with another illustrative embodiment of the present invention;

FIG. 8 is a plan view of a fabric grooming device in accordance with another illustrative embodiment of the present invention showing the controller of FIG. 7 associated therewith;

FIG. 9 is a side-section view of the fabric grooming device of FIG. 8;

FIG. 10 is a schematic diagram of a control circuit in accordance with another illustrative embodiment of the present invention;

FIG. 11 is a schematic diagram of a control circuit in accordance with still another aspect of the present invention;

FIG. 12 is a logic diagram of operational steps in accordance with another illustrative embodiment of the present invention;

### DETAILED DESCRIPTION OF THE INVENTION

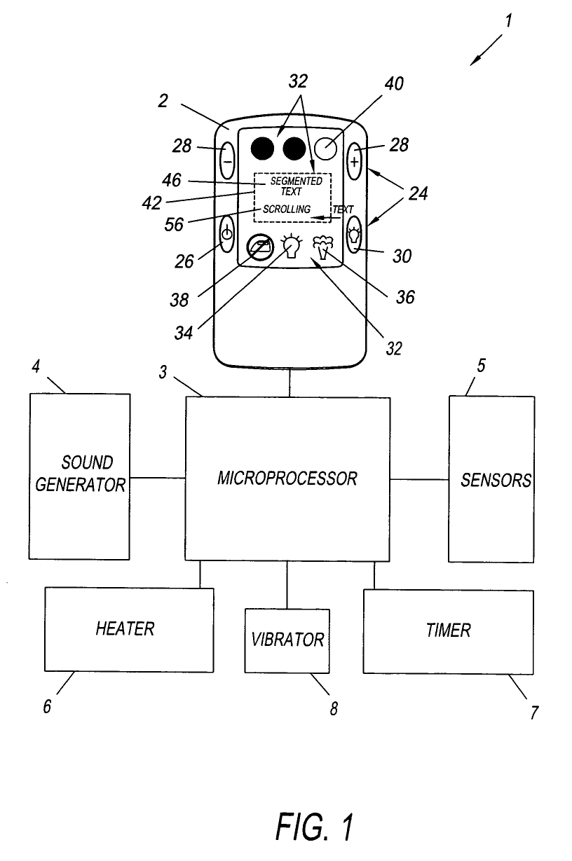

Referring to the drawings and in particular, FIG. 1, there is shown a controller in accordance with an illustrative embodiment of the present invention generally represented by reference numeral 1. Controller 1 has at least an interface 2, a microprocessor 3, preferably a sound generator 4, one or more sensors 5, a heater 6, and preferably a timer 7. Controller 1 may also have any of a variety of other features, such as for example, a vibrator 8.

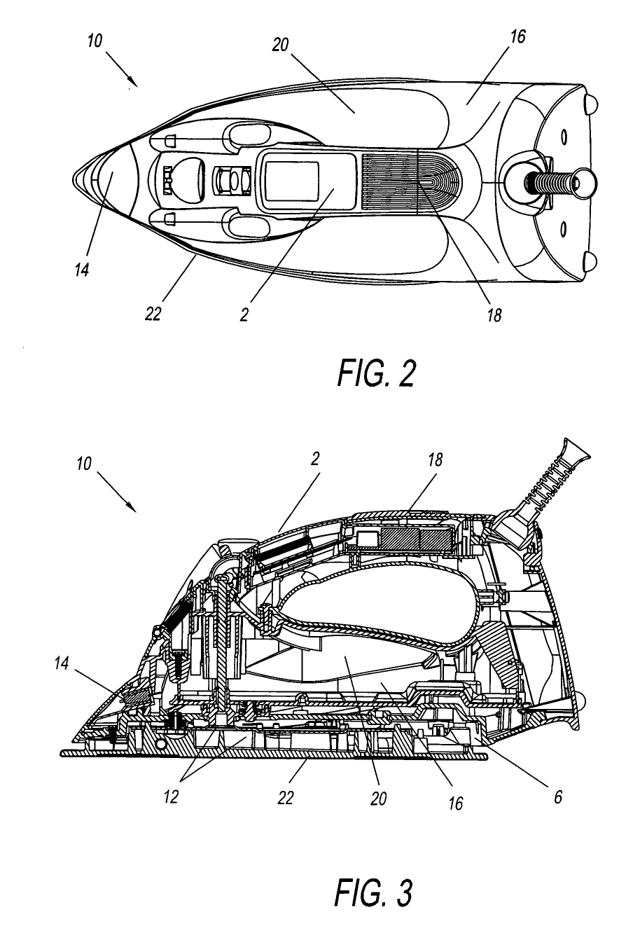

Referring to FIGS. 2 and 3, controller 1 is illustratively shown in association with a fabric grooming device generally represented by reference numeral 10. It is noted however that controller 1 can be operatively connected with any of a variety of different grooming devices. Device 10 can have any of a variety of features, such as, for example, a steam generator 12, a head light 14, a housing 16 with an ergonomic handle 18, a fluid reservoir 20, and a heating plate 22.

Referring again to FIG. 1, interface 2 preferably has one or more input selectors 24 and preferably one or more output indicators 32. Interface 2 can have any of a variety of configurations or shapes. Interface 2 preferably cooperates with input selectors 24 and output indicators 32 to facilitate operative communication between the user and device 10.

Input selectors 24 as shown in FIG. 1, are in the form of buttons. However, input selectors 24 can have a variety of other configurations. For example, one or more input selectors 24 may be in the form of a touch-panel (e.g., LCD or LED), a switch, a knob, a roller or any other like structure, suitable for user interaction.

Input selectors 24 as shown in FIG. 1, preferably include at least one “on/off” power selector 26 for activating and/or deactivating device 10, at least one setting selector 28 for setting device 10 in any of a variety of operational modes, and at least one optional selector 30 for manipulating any of a variety of components and/or features associated with device 10. Preferably, each input selector 24 has an appropriate symbol to provide the user with an understanding as to the corresponding function and/or operation associated with the particular input selector. For example, a “+” symbol to indicate “up” or “increase” and/or a “−” symbol to indicate “down” or “decrease” may be used with setting selector 28, a light or lamp icon may be associated with a selector for activating/de-activating a lamp feature, a universal “on/off” icon may be used with power selector 26, and/or any other icon or symbol appropriately representing a function/operation may be used with any of a variety of different input selectors.

The power selector 26 can be a master switch that is either directly or indirectly connected to a power source (not shown). Power selector 26 can be located or positioned to prevent any inadvertent or unwanted interaction therewith (i.e., accidental shut-off). Power selector 26 preferably enables the user to manually activate and/or deactivate device 10 at any time.

The setting selector 28 can be set to any of a variety of settings. Adjusting setting selector 28 from one setting to another preferably allows the user to control selectively the temperature and/or fabric setting to correspond with any of a variety of different fabrics and/or fabric combinations. This provides an optimal grooming effect and prevents any damage to such fabrics. In another aspect of the invention, additional setting selectors may be used with any of the various components and/or features associated with device 10.

The one or more optional selectors 30, as indicated above, can be operatively connected with any of the various features of device 10. For example, in one aspect of the invention, optional selector 30 can be connected with head light 14 and operate to activate/deactivate and/or otherwise manipulate the light as desired. In another aspect of the invention, optional selector 30 can be operatively connected with steam generator 12 to selectively manipulate the level of steam generation. Additional and/or other similar selector operations are foreseeable and fall within the scope of the present invention.

The output indicators 32, in contrast to input selectors 28, preferably provide operative feedback to the user. Output indicators 32 can preferably be visible via interface 2, audible via sound generator 4, tactile via vibrator 8, or any combination of the same. Output indicators 32 can be either directly or indirectly operatively connected with interface 2. A visible output indicator can be provided by any of a variety of optical devices including, for example, one or more light emitting diodes (LED), a liquid crystal display (LCD), illuminated symbols and/or icons, or any combination of the same. Similarly, an audible output indicator can be provided by any of a variety of audio devices such as, for example, a speaker or a combination of speakers. Further, a tactile output indicator may be provided for example by a motor driven eccentric weight. The various optical, audio and/or vibrating devices are preferably suitable to generate a steady, patterned and/or variable signal for any length of time and/or in any combination desired for an intended objective.

In an aspect of the invention, a combination of output indicators 32 is provided as shown in FIG. 1. Each of these output indicators 32 preferably provides specific information to the user. For example, a light indicator 34 can provide information as to the status of head light 14, a steam indicator 36 can provide information as to the status of steam generator 12, an auto-off indicator 38 can provide information as to a particular operating mode with device 10, a temperature and/or fabric setting indicator 40 can provide information as to the temperature setting, and/or a display indicator 42 can provide various other information pertaining to the operation of device 10. Other indicators may also be used as needed to enhance user convenience. It is noted that the above noted indicators are preferably operatively connected to interface 2, microprocessor 3, sound generator 4, sensors 5, heater 6, timer 7, vibrator 8 or any combination thereof.

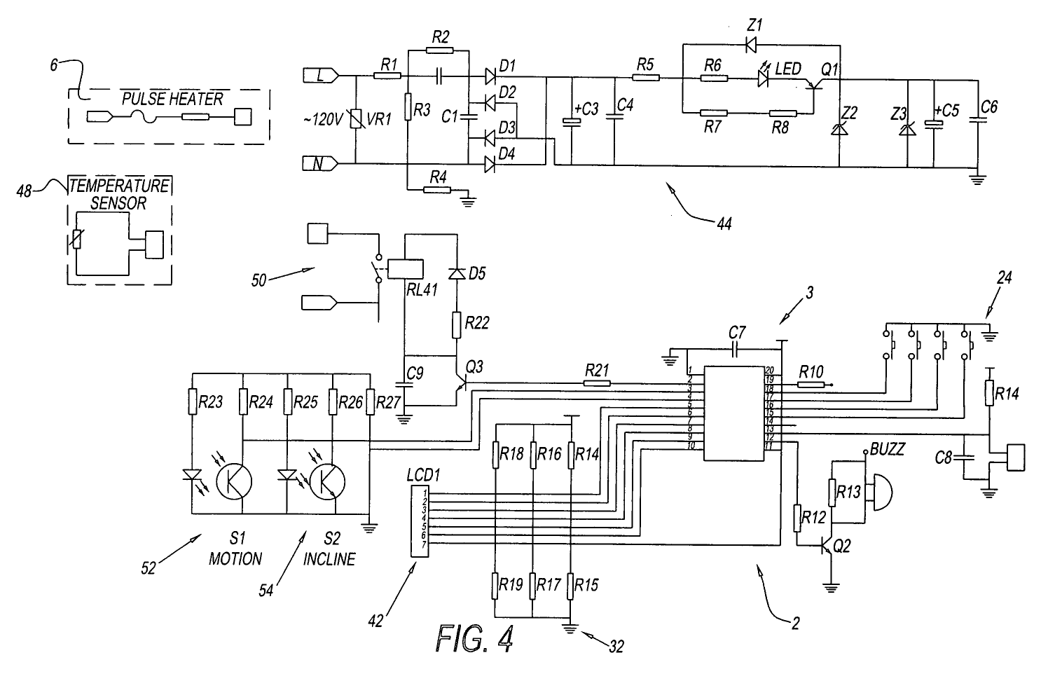

Referring to FIG. 4, an illustrative configuration of the circuitry for controller 1 is shown. As shown, a voltage regulator 44 is preferably operatively connected with interface 2, microprocessor 3, sensors 5, and heater 6. In other aspects of the invention, various configurations and/or components may also be used with and/or in place of any of the above noted components. For example, sound generator 4, timer 7 and/or vibrator 8 may additionally and/or alternatively be operatively connected with the control circuit.

Voltage regulator 44 is preferably used to provide a regulated voltage for use internally in controller 1. Other power regulating circuits may also be provided such as for example, a brownout protection circuit (not shown) that protects the microprocessor 3 from damage when the power supply falls below a predetermined level at which the operation of the microprocessor becomes unpredictable. The brownout circuit can halt operation in the event of a voltage brownout condition. When the voltage re-stabilizes, controller 1 and/or microprocessor 3 will reset.

It is noted that a power source (not shown) preferably provides power to controller 1. A battery may act as the power source. Alternatively, the power source may be a generator or a 12-volt or other DC converter. The power source preferably supplies a nominal voltage sufficient to power controller 1 and device 10.

Interface 2 is shown operatively connected to input selectors 24, output indicators 32, and display 42.

Display 42 in one aspect of the invention is preferably a segmented LCD display suitable for displaying segmented text 46 as shown in FIG. 1. Preferably, segmented text 46 can assist the user in efficiently and accurately selecting an appropriate temperature and/or fabric setting for a particular fabric. Display 42 in another aspect of the invention is preferably also suitable to additionally, or alternatively, display discrete images. These discrete images will preferably be universally understandable. For example, in the fabric/garment industry it is known to identify different fabric or classes of fabric using dots. These dots are arranged in a pattern or sequence that corresponds to a universally accepted index of temperature and/or fabric settings for optimally grooming a particular fabric. For example, acrylic is generally represented by a single dot, rayon is generally represented by two dots, and cotton is generally represented by three dots. Thus, display 42, in cooperation with microprocessor 3, preferably enables the user to effectively and accurately select an appropriate temperature and/or fabric setting for a particular fabric with or without the text feature.

Microprocessor 3 preferably facilitates communication between the various component parts of controller 1 and/or device 10. Microprocessor 3 preferably cooperates with sensors 5 to selectively manipulate the various components of controller 1 and/or device 10 according to a specified mode or setting. Microprocessor 3 preferably has memory to store control data. Under data control, microprocessor 3 interprets input from sensors 5 and interface 2 and performs all of the timing and control necessary to operate controller 1.

Timer 7 may be a separate component or may be part of microprocessor 3. Timer 7 can be an electronic clock or timer used to ensure that heater 6, output indicators 32 and/or any other appropriate feature/component of controller 1 and/or device 10 is activated or deactivated at and/or for an appropriate time corresponding to sensory data and/or a predefined operational setting.

In one aspect of the invention, sensors 5 preferably include at least a temperature sensor 48, an impact sensor 50, a motion sensor 52, and an incline sensor 54. It is noted that these sensors can have a variety of configurations and/or forms. Temperature sensor 48 preferably cooperates with timer 7 and/or microprocessor 3 to maintain heater 6 at a temperature corresponding to a selected setting and/or other sensory input. Impact sensor 50, motion sensor 52, and incline sensor 54, are preferably operatively connected with a safety deactivation (i.e., auto-shut-off) feature. That is, impact sensor 50 preferably cooperates with timer 7 and/or microprocessor 3 to automatically deactivate controller 1 and/or device 10 in response to sensory input ascertained as a consequence of device 10 being dropped or otherwise subjected to impact. Motion sensor 52 preferably cooperates with timer 7 and/or microprocessor 3 to automatically deactivate controller 1 and/or device 10 in response to sensory input ascertained while device 10 is activated and in an operative state. While incline sensor 54 preferably cooperates with timer 7 and/or microprocessor 3 to automatically deactivate controller 1 and/or device 10 in response to sensory input ascertained while device 10 is activated and in an inoperative or rest state.

When sensors 5 are satisfied, the circuit for controller 1 is completed. Conversely, when one or more of the sensors 5 are not satisfied the controller circuit is incomplete. Hence, once activated, device 10 preferably remains operative as long as sensors 5 are satisfied. Once any one of the sensors 5 become dissatisfied, device 10 is disengaged or deactivated until intentionally reactivated by the user.

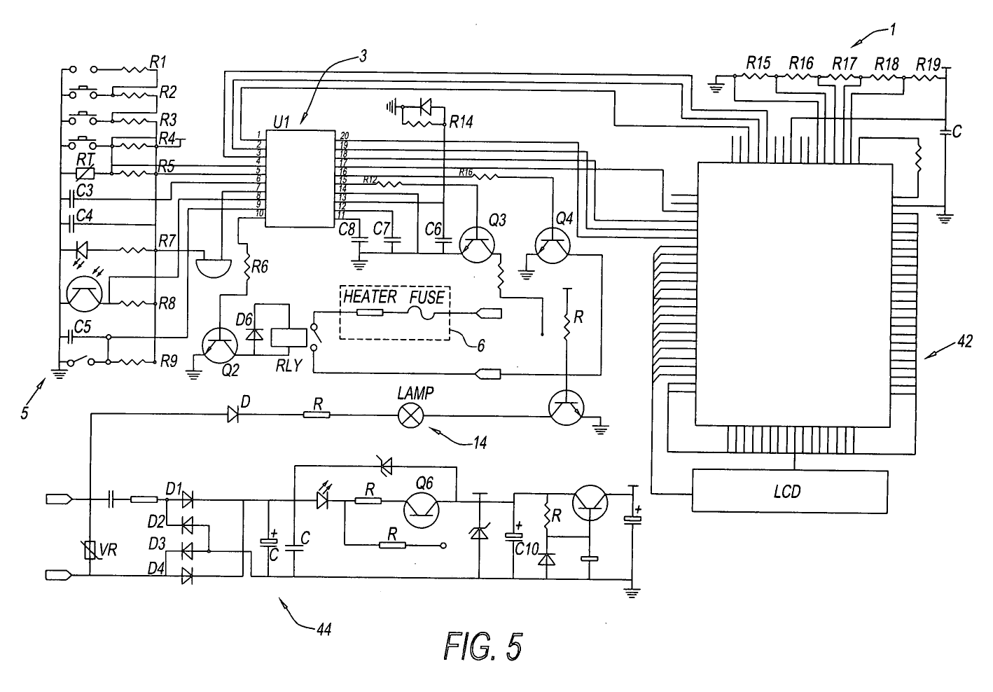

Referring to FIG. 5, there is shown an illustrative circuit configuration according to another aspect of the present invention in which display 42 is preferably a scrolling LCD display suitable for displaying scrolling text 56 as shown in FIG. 1. Preferably, scrolling text 56 allows for more detailed information to be communicated to the user and thereby further assists the user to efficiently and accurately select an appropriate temperature and/or fabric setting appropriate for a particular fabric.

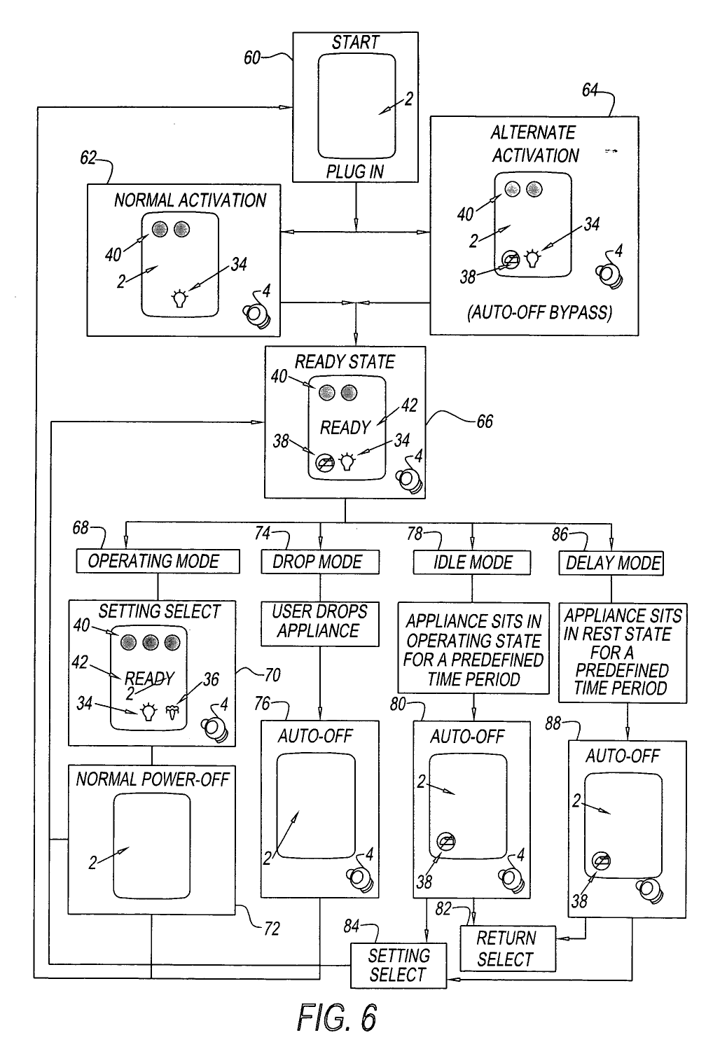

Referring now to FIG. 6, a logic diagram shows the operational steps associated with the controller 1 and the method of the present invention. As shown in FIG. 6, the following steps may be followed by microprocessor 3 and/or controller 1 during the operation of device 10.

Controller 1 can preferably be activated in at least one of two ways, normally by connecting device 10 to a power source (not shown) and pressing power selector 26 for a relatively short period of time (e.g., less than about 3 seconds), or alternatively by connecting device 10 to the power source and pressing power selector 26 for a relatively long period of time (e.g., more than about 3 seconds). The period of time associated with the alternate approach is preferably of sufficient duration to require an intentional act by the user.

As shown in block 60, prior to activation of controller 1, interface 2 is preferably not active. The activation of controller 1 is shown in logic blocks 62 and 64. When controller 1 is normally activated as reflected by block 62, controller 1 and/or device 10 power-up to an initial setting (e.g., a default setting, a pre-selected setting or a return setting). Preferably, setting indicator 40 indicates the initial setting to the user. Head light 14 may be either automatically or manually activated during and/or subsequent to the activation process. The user may at any time press an optional head light selector 30 to deactivate head light 14. Head light indicator 34 preferably indicates the status of head light 14 to the user. At any time, during and/or after the activation process, the user can utilize one or more setting selectors 28 to change the temperature and/or fabric setting. Preferably, sound generator 4 produces an audible signal (e.g., a single beep) on each setting. Once a desired temperature and/or fabric setting is selected, such setting is preferably reflected by setting indicator 40.

Should controller 1 and/or device 10 be activated using the alternate approach (i.e., pressing the power selector for a relatively extended period of time), as reflected by block 64, preferably sound generator 4 produces a distinct audible signal (e.g., three beeps) and incline sensor 54 is preferably deactivated. This deactivation of incline sensor 54 is reflected by auto-off indicator 38 blinking at a rate of, for example, about every one-half (½) second. It is noted that both the motion sensor 52 and the impact sensor 50 remain operative.

After activation and setting selection, once the selected temperature and/or fabric setting is achieved, a text message or a symbol/icon preferably appears in display 42 indicating a state of readiness. This step is shown in block 66. It is noted that setting indicator 40, which reflects the selected setting, can be either in display 42 or distinct and separate therefrom.

Once the ready state is achieved, controller 1 and device 10 can be operated as reflected in block 68. In the operating mode, the user is able to groom any of a variety of fabrics as desired until finished. Also, the user can change temperature and/or fabric settings as desired at any time via setting selector 28. These operations are reflected by block 70. The current temperature and/or fabric setting is preferably indicated by setting indicator 40. It is noted that at one or more predefined settings, steam generator 12 may be automatically and/or manually activated. Preferably, steam generator 12 can only be activated when the temperature and/or fabric setting is appropriate for generating steam. The status of steam generator 12 is preferably indicated via steam indicator 36.

When the user is finished with operating device 10, the user can manually deactivate or power-off controller 1 and/or device 10 by pressing power selector 26. This step is reflected in block 72. It is noted that after deactivation, if the user has left device 10 connected to power source, then upon reactivation the last temperature and/or fabric setting will preferably be reinstated. Alternatively, if the user disconnects device 10 from power source, then upon reactivation the last temperature and/or fabric setting resets.

As reflected by block 74, during operation, should the user drop device 10, impact sensor 50 directly or indirectly deactivates or powers-off device 10. Once device 10 is deactivated, one or more output indicators 32 preferably communicate the need for action by the user. For example, as reflected in block 76, in one aspect of the invention, a message or symbol/icon appears instructing the user to unplug and inspect device 10 for damage before continued operation. Additionally, or alternatively, sound generator 4 produces a signal (e.g., a constant beeping) until device 10 is unplugged or disconnected from the power source. Thus, once device 10 is dropped, the user preferably must disconnect the device from the power source and go through the activation process outlined in blocks 62 to 66 before device 10 can be operated.

As reflected in block 78, during operation, should the user allow device 10 to sit in an operative state for a predefined extended period of time (e.g., about 30 seconds), motion sensor 52 directly or indirectly deactivates or powers-off device 10. Alternatively, only certain components of device 10 may be deactivated. For example, only heater 6 can be deactivated. After an appropriate deactivation, one or more output indicators 32 preferably communicate the need for action by the user. For example, as reflected in block 80, in one aspect of the invention, a message and/or symbol/icon appears indicating to the user the status of device 10, and/or instructing the user to move device 10 or press an input selector 24 for reactivation. Additionally, or alternatively, sound generator 4 produces a signal (e.g., three beeps) upon deactivation, the back light powers-off, and/or the head light powers-off. Thus, if device 10 is idle for an extended period of time while in the operative state, the user preferably must take specific action for reactivation to occur. Upon reactivation, preferably the last temperature and/or fabric setting is reinstated as reflected in block 82. However, as shown in block 84, a new temperature and/or fabric setting may also be selected.

As reflected in block 86, during operation and provided incline sensor 54 has not been deactivated using the alternate activation process, if the user allows device 10 to sit in an inoperative or rest state for a predefined extended period of time (e.g., about 10 minutes), incline sensor 54 directly or indirectly deactivates or powers-off device 10. Alternatively, only certain components of device 10 may be deactivated. For example, only heater 6 can be deactivated. After an appropriate deactivation, one or more output indicators 32 preferably communicate the need for action by the user. For example, as reflected in block 88, in one aspect of the invention, a message and/or symbol/icon appears indicating to the user the status of device 10, and/or instructing the user to move device 10 or press an input selector 24 for reactivation. Additionally, or alternatively, sound generator 4 produces a signal (e.g., three beeps) upon deactivation, the back light powers-off, and/or the head light powers-off. Thus, if device 10 is idle for an extended period of time while in the rest or inoperative state, the user preferably must take specific action to initiate reactivation. Upon reactivation, preferably the last temperature and/or fabric setting is reinstated as reflected in block 82. However, as shown in block 84, a new temperature and/or fabric setting may also be selected.

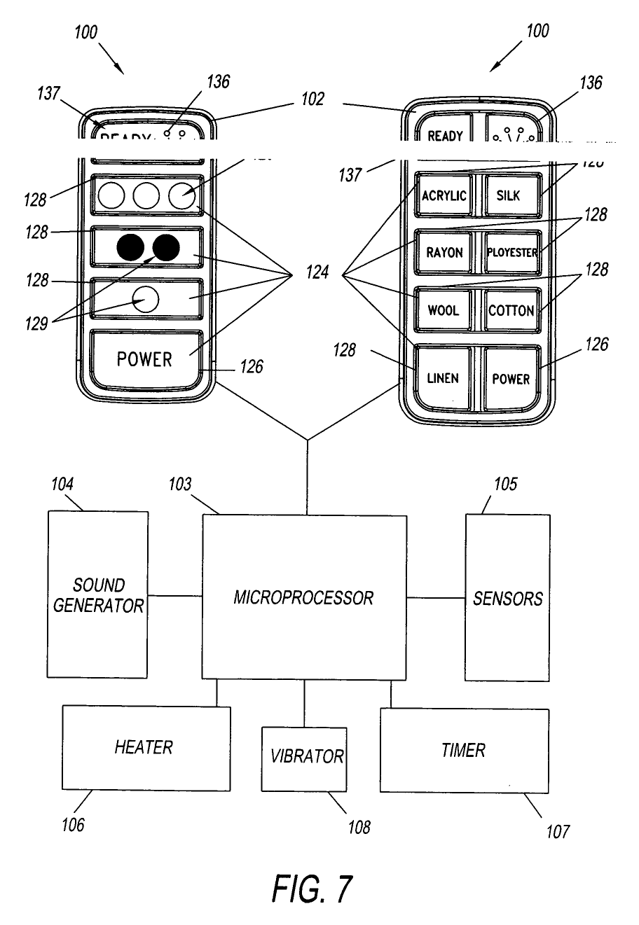

Having described some of the preferred aspects of the present invention, it is appreciated that details may be modified in a variety of ways and that alternative embodiments are also within the scope of the present invention. For example, referring to FIG. 7, another illustrative embodiment of the controller generally represented by reference numeral 100 is shown. Controller 100, as with the previous embodiment, preferably has an interface 102, a microprocessor 103, a sound generator 104, one or more sensors 105, a heater 106, and a timer 107. Controller 100 may also have any of a variety of other features, such as for example, a vibrator 108.

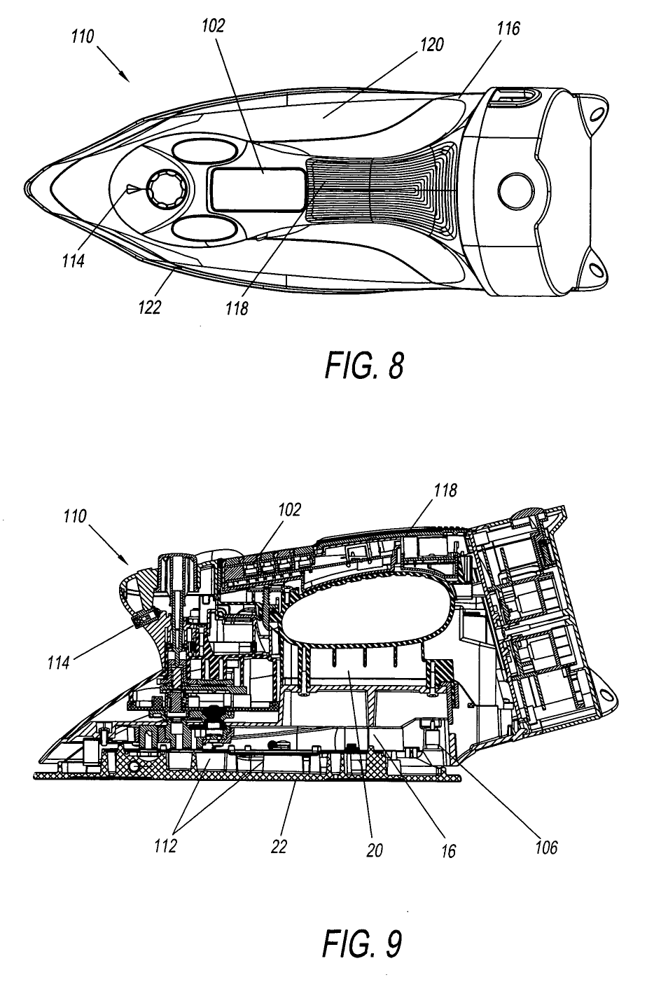

Referring to FIGS. 8 and 9, as with the embodiment previously discussed, controller 100 is preferably operatively connected with a fabric grooming device 110 such as that shown in FIGS. 8 and 9. Device 110 preferably has, among other features, a steam generator 112, a spray nozzle 114, a housing 116 with an ergonomic handle 118, a fluid reservoir 120, and a heating plate 122.

Referring again to FIG. 7, interface 102 preferably has one or more input/output buttons 124. Buttons 124 preferably accomplish the same objectives as input selectors 24 and/or output indicators 32 previously discussed. Buttons 124 preferably provide a way for operative communication between the user and device 110 and can have any of a variety of configurations and/or shapes. For example, one or more buttons 124 can be a touch-sensitive panel with selectively illuminated diodes incorporated therein.

Buttons 124 as shown in FIG. 7, preferably include at least an “on/off” power button 126 for activating and/or deactivating device 110, and/or one or more control buttons 128 for setting device 110 in any of a variety of operational modes. Other input/output buttons may also be provided. Preferably, each button 124 has an appropriate, preferably universally understood symbol associated therewith to provide the user with an understanding as to the corresponding function and/or operation associated with the particular button. Buttons 124 can be either directly or indirectly operatively connected with interface 102 and can have a source of illumination associated therewith.

As shown in FIG. 7, any number and/or combination of buttons 124 may be provided. For example, in one aspect of the invention, interface 102 preferably has power button 126 and three control buttons 128. The three control buttons 128 preferably each have a universally understood symbol 129 associated therewith. Symbols 129 preferably correspond to a universally accepted index of temperature and/or fabric settings for optimally grooming various fabrics.

In another aspect of the invention, interface 102 can have power button 126 and at least seven control buttons 128, each corresponding to a specific temperature and/or fabric setting. For example, a control button labeled “cotton” corresponds to a temperature setting that is appropriate for use with a fabric made of cotton. Thus, the user can readily and directly select an appropriate temperature and/or fabric setting for an intended use.

In still another aspect of the invention, one or more button 124 preferably provides specific operational information to the user. For example, once a setting is selected, either by default or by the user via control buttons 128, the appropriate button corresponding to the selected setting may be illuminated to indicate to the user the current setting. Other user indicators may also be provided as needed to provide appropriate operational information and to enhance the user's overall convenience and/or to improve safety. For example, a steam indicator 136 can provide information as to the status of steam generator 112, and/or a ready indicator 137 can provide information as to the operational readiness of device 110. It is noted that the above noted indicators are preferably operatively connected to interface 102, microprocessor 103, sound generator 104, sensors 105, heater 106, timer 107, and/or vibrator 108.

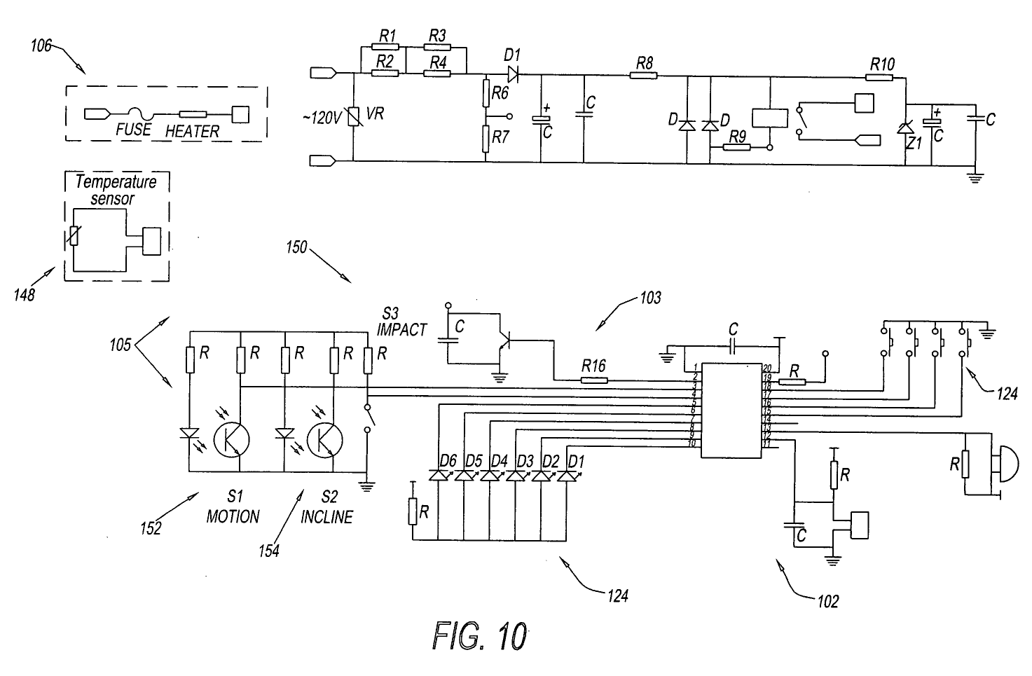

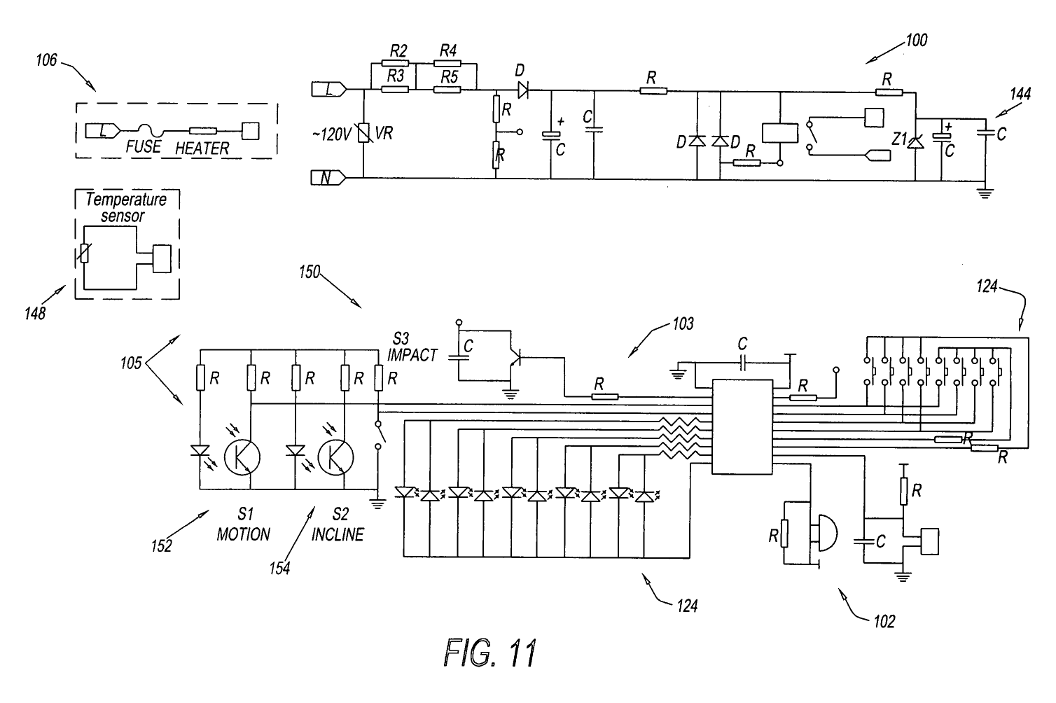

Referring now to FIGS. 10 and 11, an illustrative configuration of the circuitry for controller 100 is shown. As shown, a voltage regulator 144 preferably operatively connected with interface 102, microprocessor 103, sensors 105, and heater 106. In other aspects of the invention, various configurations and/or components may also be used in conjunction with and/or in place of any of the above noted components. For example, sound generator 104, timer 107 and/or vibrator 108 may additionally and/or alternatively be operatively connected with the control circuit.

Voltage regulator 144 is preferably substantially identical to voltage regulator 44 previously discussed with respect to the foregoing embodiment, but need not be, as other power regulating circuits may also be provided. A power source preferably provides power to controller 100. Such power source preferably supplies a nominal voltage sufficient to power controller 100 and device 110.

Interface 102 and input/output buttons 124 are preferably integrally operatively connected. In this aspect of the invention, interface 102 and input/output buttons 124 preferably integrally operate together to facilitate operative communication between device 110 and the user. Thus, interface 102 and/or input/output buttons 124, in cooperation with microprocessor 103, preferably enables the user effectively and accurately select an appropriate temperature and/or fabric setting for an intended use.

Microprocessor 103, under stored data control, preferably interprets input from interface 102 and sensors 105, provides information output to the user via interface 102, sound generator 104, and/or vibrator 108, and performs all of the timing and control necessary to operate controller 100 and/or device 110. In one aspect of the invention, timer 107 is preferably used to ensure that heater 106, buttons 124 and/or any other appropriate feature/component of controller 100 and/or device 110 is activated or deactivated at and/or for an appropriate time corresponding to sensory data and/or a predefined operational setting.

As shown in FIGS. 10 and 11, sensors 105 including temperature sensor 148, impact sensor 150, motion sensor 152, and incline sensor 154 preferably cooperate with timer 107 and/or microprocessor 103 to complete the control circuit. Hence, once activated, device 110 preferably remains operative as long as the control circuit is complete (i.e., sensors 105 are all satisfied). Once the control circuit is compromised (i.e., one or more sensor 105 become dissatisfied), the control circuit is incomplete and device 110 is disengaged or deactivated until intentionally reactivated by the user.

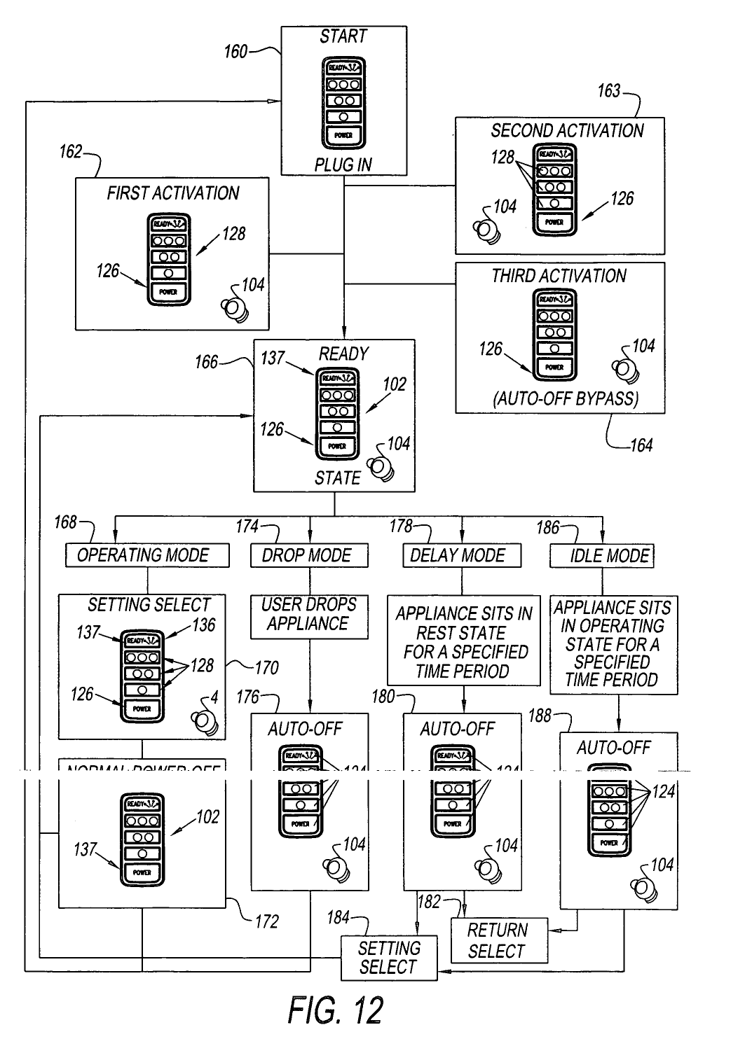

Referring to FIG. 12, a logic diagram shows the operational steps associated with the controller 100. As shown in FIG. 12, the following steps may be followed by microprocessor 103 and/or controller 100 during the operation of device 110.

Controller 100 can preferably be activated in at least three ways, first, by connecting device 110 to a power source (not shown) and pressing any control button 128 preferably for a relatively short period of time (e.g., less than about 3 seconds), second, by connecting device 110 to the power source and pressing power button 126 for preferably a relatively short period of time (e.g., less than about 3 seconds), or third, by connecting device 110 to the power source and pressing power button 126 for preferably a relatively long period of time (e.g., more than about 3 seconds). The period of time associated with the third approach is preferably of sufficient duration to require an intentional act by the user.

As shown in block 160, prior to activation of controller 100, interface 102 is preferably not active. Activation of controller 100 is represented by logic blocks 162, 163 and 164. When controller 100 is activated using the first approach as reflected by block 162, controller 100 and/or device 110 preferably powers-up to the temperature and/or fabric setting corresponding to the pressed control button 128. At this point, preferably, the power button 126 and the selected control button 128 are illuminated as reflected in block 162 to indicate the current setting to the user. At any time, during and/or after the activation process, the user can utilize control buttons 128 to change the temperature and/or fabric setting. Preferably, sound generator 104 produces an audible signal (e.g., a single beep) upon each button press. Once a desired temperature and/or fabric setting is selected, the corresponding control button 128 will be illuminated to indicate the current setting to the user.

When controller 100 is activated using the second approach (i.e., pressing the power selector for a relatively short period of time), as reflected by block 163, controller 100 and/or device 110 powers-up to an initial setting (e.g., a default setting or a return setting). Preferably, power button 126 and the control button 128 associated with the default setting are illuminated to indicate the current setting to the user. At any time, during and/or after the activation process, the user can utilize control buttons 128 to change the temperature and/or fabric setting. Preferably, sound generator 104 produces an audible signal (e.g., a single beep) upon each button press. Once a desired temperature and/or fabric setting is selected, the selected control button 128 is preferably illuminated to indicate the current setting to the user.

Should controller 100 and/or device 110 be activated using the third approach (i.e., pressing the power button for a relatively extended period of time), as reflected by block 164, preferably sound generator 104 produces a distinct audible signal (e.g., three beeps) and incline sensor 154 is preferably deactivated. This deactivation of incline sensor 154 is reflected by power button 126 blinking at a rate of, for example, about every one-half (½) second. It is noted that both the motion sensor 152 and the impact sensor 150 remain operative.

After activation and setting selection, once the selected temperature and/or fabric setting is achieved, ready indicator 137 is preferably illuminated indicating a state of readiness. This step is shown in block 166. Also, sound generator 104 may produce a distinct audible signal (e.g., two beeps). Once the ready state is achieved, controller 100 and device 110 can be operated as reflected in block 168. In the operating mode, the user is able to groom any of a variety of fabrics as desired until finished. Also, the user can change temperature and/or fabric settings as desired at any time via control buttons 128. These operations are reflected by block 170. The current temperature and/or fabric setting is preferably indicated by the illumination of the appropriate corresponding control button 128. It is noted that at one or more predefined settings, steam generator 112 may be automatically and/or manually activated. Preferably, steam generator 112 can only be activated when the temperature and/or fabric setting is appropriate for generating steam. The status of steam generator 112 is preferably indicated via steam indicator 136.

When the user is finished with operating device 110, the user can manually deactivate or power-off controller 100 and/or device 110 by pressing power button 126. This step is reflected in block 172. It is noted that after deactivation, if the user has left device 110 connected to power source, then upon reactivation the last temperature and/or fabric setting will preferably be reinstated. Alternatively, if the user disconnects device 110 from power source, then upon reactivation the last temperature and/or fabric setting resets.

As reflected by block 174, during operation, should the user drop device 110, impact sensor 150 directly or indirectly deactivates or powers-off device 110. Once device 110 is deactivated, one or more input/output buttons 124 preferably communicate the need for action by the user. For example, as reflected in block 176, in one aspect of the invention, all of the buttons associated with interface 102 preferably flash or blink intermittently at a predefined rate (e.g., at about every one-half (½) second) indicating to the user the need to unplug and inspect device 110 for damage before continued operation. Additionally, or alternatively, sound generator 104 produces a signal (e.g., a constant beeping) until device 110 is unplugged or disconnected from the power source. Thus, once device 110 is dropped, the user preferably must disconnect the device from the power source and go through the activation process outlined in blocks 162 to 166 before device 110 can be operated.

As reflected in block 178, during operation, should the user allow device 110 to sit in an operative state for a predefined extended period of time (e.g., about 130 seconds), motion sensor 152 directly or indirectly deactivates or powers-off device 110. Alternatively, only certain components of device 110 may be deactivated. For example, only heater 106 can be deactivated. After an appropriate deactivation, one or more input/output buttons 124 preferably communicate the need for action by the user. For example, as reflected in block 180, in one aspect of the invention, all of the buttons associated with interface 102 preferably flash or blink intermittently at a predefined rate (e.g., at about every one-half (½) second) indicating to the user the need to move device 110 or press an input/output button 124 for reactivation. Additionally, or alternatively, sound generator 104 produces a signal (e.g., three beeps) upon deactivation, the back light powers-off, and/or the head light powers-off. Thus, if device 110 is idle for an extended period of time while in the operative state, the user preferably must take specific action for reactivation to occur. Upon reactivation, preferably the last temperature and/or fabric setting is reinstated as reflected in block 182. However, as shown in block 184, a new temperature and/or fabric setting may also be selected.

As reflected in block 186, during operation and provided incline sensor 154 has not been deactivated using the alternate activation process, if the user allows device 110 to sit in an inoperative or rest state for a predefined extended period of time (e.g., about 10 minutes), incline sensor 154 directly or indirectly deactivates or powers-off device 110. Alternatively, only certain components of device 110 may be deactivated. For example, only heater 106 can be deactivated. After an appropriate deactivation, one or more input/output buttons 124 preferably communicate the need for action by the user. For example, as reflected in block 188, in one aspect of the invention, all of the buttons associated with interface 102 preferably flash or blink intermittently at a predefined rate (e.g., at about every one-half (½) second) indicating to the user the need to move device 110 or press an input/output button 124 for reactivation. Additionally, or alternatively, sound generator 104 produces a signal (e.g., three beeps) upon deactivation, the back light powers-off, and/or the head light powers-off. Thus, if device 110 is idle for an extended period of time while in the rest or inoperative state, the user preferably must take specific action to initiate reactivation. Upon reactivation, preferably the last temperature and/or fabric setting is reinstated as reflected in block 182. However, as shown in block 184, a new temperature and/or fabric setting may also be selected.

The present invention having been thus described with particular reference to the illustrated embodiments thereof, it will be obvious that various changes and modifications may be made therein without departing from the spirit of the present invention as defined herein.

What is claimed is:

1. A controller for use with a fabric grooming device comprising:
an interactive user interface with one or more input selectors and one or more output indicators,
wherein said interface is operatively connected to a microprocessor.

2. The controller of claim 1, wherein each of said one or more input selectors have an image or symbol associated therewith for identifying the function and/or operation corresponding thereto.

3. The controller of claim 2, wherein at least one of said one or more input selectors is a touch screen panel.

4. The controller of claim 2, wherein at least one of said one or more input selectors is an LCD panel.

5. The controller of claim 2, wherein at least one of said one or more input selectors is an LED panel.

6. The controller of claim 2, wherein said one or more input selectors are selected from a group consisting of a button, a switch, a roller, and a knob.

7. The controller of claim 1, wherein each of said one or more output indicators have an image or symbol for identifying the function and/or operation corresponding thereto.

8. The controller of claim 7, wherein at least one of said one or more output indicators is a display panel.

9. The controller of claim 7, wherein at least one of said one or more output indicators is an LCD panel.

10. The controller of claim 7, wherein at least one of said one or more output indicators is an LED panel.

11. The controller of claim 7, wherein said one or more output indicators are selected from a group consisting of a button, a switch, a roller, and a knob.

12. The controller of claim 1, wherein said one or more output indicators are a visual indicator.

13. The controller of claim 1, wherein said one or more output indicators are an audible indicator.

14. The controller of claim 1, wherein said one or more output indicators are a tactile indicator.

15. The controller of claim 1, wherein said microprocessor is operatively connected to a sound generator, one or more sensors, and/or a heater.

16. The controller of claim 15, wherein said microprocessor is also operatively connected to a timer.

17. The controller of claim 16, wherein said microprocessor is operatively connected to a vibrator.

18. A controller for a fabric grooming device comprising:
a digital interface;
a microprocessor operatively connected with said interface;
wherein said interface and/or said microprocessor are operatively connected to any of a variety of operational features of said fabric grooming device to facilitate interactive operational control thereof.

19. A controller operatively associated with a fabric grooming device comprising:
a digital interface for providing interactive communication between a user and said grooming device,
wherein said interface is operatively connected with a microprocessor and one or more sensors.

20. A user interface associated with a control for a fabric grooming device, the user interface comprising:
one or more input selectors for inputting user instruction;
one or more output indicators for outputting operational information; and
a microprocessor operatively connected to said input selectors and said output selectors.

21. A user interface associated with a control for a fabric grooming device, the user interface comprising:
one or more input selectors for inputting user instruction;
one or more output indicators for outputting operational information; and
a microprocessor operatively connected to said input selectors and said output selectors.

22. An interface operatively associated with a fabric grooming device, comprising:
one or more input selectors; and
one or more output indicators.

23. A method of operation for a fabric grooming device, comprising the steps of:
providing a controller operatively connected with said grooming device, said controller having an interface with one or more input selectors and one or more output indicators;
activating said grooming device by connecting said grooming device to a power source and pressing a predefined input selector for a predefined period of time;
operating said grooming device to groom any of a variety of fabrics;
deactivating said grooming device by pressing said predefined input selector a time and/or disconnecting said grooming device from said power source.

24. The method of claim 23, wherein said interface is not active prior to the activating step.

25. The method of claim 23, wherein said one or more input selectors may be used to select any of a variety of temperature and/or fabric settings at any time during and/or after activation.

26. The method of claim 25, further comprising a predefined output selector that indicates when the selected temperature and/or fabric setting is reached.

27. The method of claim 25, further comprising an audible signal that indicates when the selected temperature and/or fabric setting is reached.

28. The method of claim 23, further comprising an impact sensor directly or indirectly automatically deactivates said grooming device when, during operation, said grooming device is dropped.

29. The method of claim 28, wherein at least one of said one or more output indicators indicates the need for action.

30. The method of claim 29, wherein said action is to disconnect said grooming device from said power source.

31. The method of claim 28, further comprising an audible signal that indicates the need for action.

32. The method of claim 31, wherein said action is to disconnect said grooming device from said power source.

33. The method of claim 23, wherein said predefined period of time is less than about 3 seconds.

34. The method of claim 23, wherein said predefined period of time is more than about 3 seconds.

35. The method of claim 34, wherein said at least one auto-off sensor is deactivated.

36. The method of claim 35, wherein said at least one auto-off sensor is an incline sensor.

37. The method of claim 23, further comprising a motion sensor that directly or indirectly automatically deactivates said grooming device when, during operation, the user allows said grooming device to sit in an operative sate for a predefined period of time.

38. The method of claim 37, wherein at least one of said one or more output indicators indicates the current status of said grooming device and/or the need for user action.

39. The method of claim 38, wherein said user action reactivates and returns said grooming device to the last temperature and/or fabric setting prior to said deactivation.

40. The method of claim 39, wherein said user action reactivates and returns said grooming device to a default temperature and/or fabric setting.

41. The method of claim 40, wherein said user action is to disconnect said grooming device from said power source.

42. The method of claim 38, wherein said user action is to move said grooming device and/or actuating said one or more input selectors.

43. The method of claim 37, further comprising an audible signal that indicates the current status of said grooming device and/or the need for user action.

44. The method of claim 43, wherein said user action reactivates and returns said grooming device to a default temperature and/or fabric setting.

45. The method of claim 44, wherein said user action is to disconnect said grooming device from said power source.

46. The method of claim 43, wherein said user action is to move said grooming device and/or actuating said one or more input selectors.

47. The method of claim 23, further comprising an incline sensor that directly or indirectly automatically deactivates said grooming device when, during operation, the user allows said grooming device to sit in an operative sate for a predefined relatively extended period of time.

48. The method of claim 47, wherein at least one of said one or more output indicators indicate the current status of said grooming device and/or the need for user action.

49. The method of claim 48, wherein said user action reactivates and returns said grooming device to the last temperature and/or fabric setting prior to said deactivation.

50. The method of claim 49, wherein said user action reactivates and returns said grooming device to a default temperature and/or fabric setting.

51. The method of claim 50, wherein said user action is to disconnect said grooming device from said power source.

52. The method of claim 48, wherein said user action is to move said grooming device and/or actuating said one or more input selectors.

53. The method of claim 47, further comprising an audible signal that indicates the current status of said grooming device and/or the need for user action.

54. The method of claim 53, wherein said user action reactivates and returns said grooming device to a default temperature and/or fabric setting.

55. The method of claim 54, wherein said user action is to disconnect said grooming device from said power source.

56. The method of claim 53, wherein said user action is to move said grooming device and/or actuating said one or more input selectors.
